(19) United States
(12) Patent Application Publication
(10) Pub. No.: US 2026/0144179 A1
(43) Pub. Date: May 28, 2026

(54) REZIDUE REAPER BLADE

(71) Applicant: TANNER SCHOFF, WALNUT, IL (US)

(72) Inventor: TANNER SCHOFF, WALNUT, IL (US)

(21) Appl. No.: 18/960,616

(22) Filed: Nov. 26, 2024

(51) Int. Cl. A01B 15/18; A01B 17/00; A01B 49/02

(52) U.S. Cl. CPC A01B 15/18; A01B 17/002; A01B 49/027

(57) ABSTRACT

The present invention is an improvement for a coulter blade for a harvester header attachment designed to slice crop residue and till soil as a harvester is harvesting a field of crops. As a harvester moves through a field of crops, the harvester header attachment's coulter blade spins on a bearing and cuts into the crop's stalks, leaves, and root balls, tilling the standing crop residue. The present invention adds a series of fins to the coulter blade, either directly or on an attachment to the coulter blade, such that the footprint of the blade is larger, allowing it to perform those functions even if not lined up perfectly with a crop row.

### REFERENCE TO RELATED APPLICATIONS

This non-provisional application claims priority of U.S. non-provisional application number Ser. No. 18/611,371 filed by Applicant on Mar. 20, 2024, the contents of which are incorporated herein by reference.

### BACKGROUND OF THE INVENTION

The present invention is an improvement to a part of the related Rezidue Reaper invention, application Ser. No. 18/611,371. The Rezidue Reaper is attached to the harvester header of a harvesting machine, which then harvests the row crop plant, and the Rezidue Reaper immediately processes the row crop plant residue in a manner that greatly increases the efficiency of how we conserve soil and gain soil health for future generations. The Rezidue Reaper, being made of steel or other strong material, is heavy enough such that the coulter blade sinks into the field a few inches, slicing a seam into the soil as it spins. When it contacts crop residue, such as a stalk, the coulter blade slices through and pulverizes the residue, pushing part of the pulverized residue into the seam in the soil.

In using the Rezidue Reaper for a harvest, the Applicant found that even a wavy coulter blade was sometimes insufficient to manage variances in row width, GPS drift, or other issues that would cause the coulter blade not to line up perfectly with the crop. The Applicant found that adding fins directly to the coulter blade or adding a base with fins to each side of the coulter blade as described herein provided far better width coverage for ensuring the crop residue was properly pulverized and integrated with the soil even when the blade wasn't lined up perfectly with the crop row.

### BRIEF DESCRIPTION OF DRAWINGS

FIG. 1 is an angled view of the preferred embodiment of the present invention with the coulter blade fins attached directly to both sides of a coulter blade.

FIG. 2 is a straight-on view of the preferred embodiment of the present invention with the coulter blade fins attached directly to both sides of a coulter blade.

FIG. 3 is a side view of the preferred embodiment of the present invention with the coulter blade fins attached directly to both sides of a coulter blade.

FIG. 4 is an angled view of the fin attachment.

FIG. 5 is a straight-on view of the fin attachment.

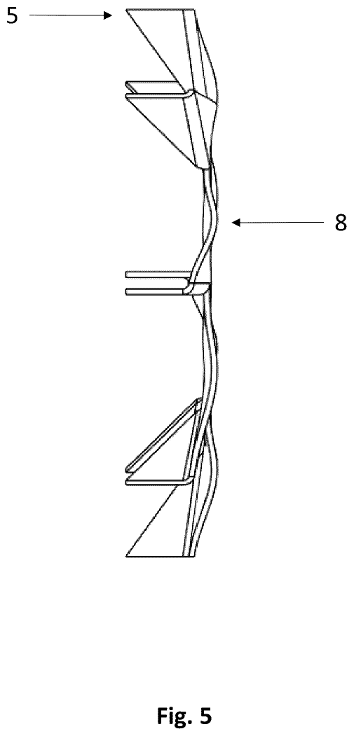

FIG. 6 is a side view of the fin attachment.

FIG. 7 is an angled view of the fin attachment placed on both sides of a coulter blade.

LEGEND FOR DRAWINGS
1. Coulter blade
2. Coulter blade fin
3. Blade bolt hole
4. Blade assembly hole
5. Fin attachment fin
6. Fin attachment bolt hole
7. Fin attachment assembly hole
8. Fin attachment
9. Fin attachment base

### DETAILED DESCRIPTION

The present invention is ideally made of steel parts, though other strong materials suitable for heavy agricultural use and of sufficient weight to absorb the impact of rocks and other hard objects in the field may be used.

The related Rezidue Reaper invention, described in U.S. patent application Ser. No. 18/611,371, is attached to the harvester header of a harvesting machine, which then harvests the row crop plant, and the Rezidue Reaper immediately processes the row crop plant residue. The Rezidue Reaper, being made of steel or other strong material, is heavy enough such that the coulter blade sinks into the field a few inches, slicing a seam into the soil as it spins. When it contacts crop residue, such as a stalk, the coulter blade slices through and pulverizes the residue, pushing part of the pulverized residue into the seam in the soil.

In using the related Rezidue Reaper invention for a harvest, Applicant found that even a wavy coulter blade was sometimes insufficient to manage variances in row width, GPS drift, or other issues that would cause the coulter blade to not line up perfectly with the crop. Applicant found that adding a series of fins directly to a wavy coulter blade in a radial pattern or a base with fins in a radial pattern as described herein to a wavy coulter blade provided far better width coverage for ensuring the crop residue was properly pulverized.

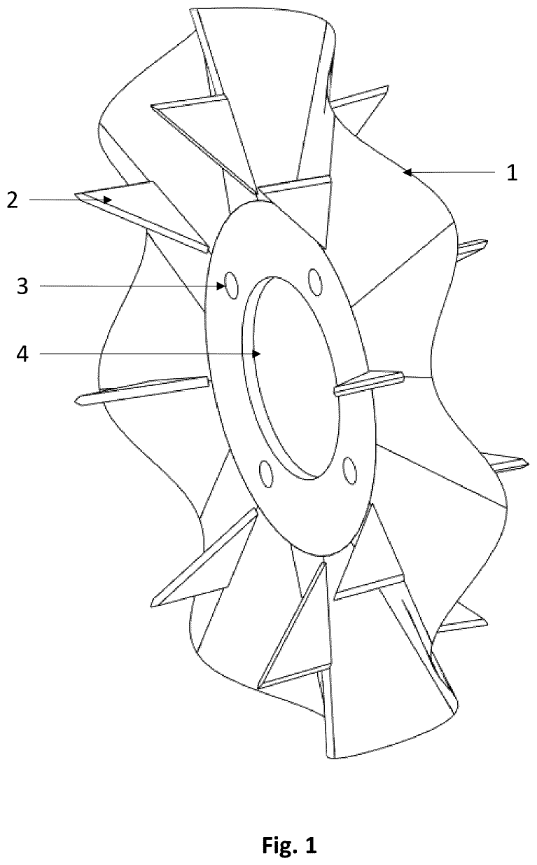

As the purpose of the present invention is to better solve the issue of being able to directly hit and pulverize the crop residue with the coulter when lineup with the crop isn't perfect, such as on a side hill or when there is GPS drift (such that the combine isn't tracking completely straight on the row), using a wavy coulter blade, as shown in FIG. 1, which has a wider footprint than a flat blade, will work the best as the type of coulter blade for the present invention, though flat or other shapes of coulter blades could be used.

The preferred embodiment of the present invention, depicted in FIG. 1, is a coulter blade (1) with a series of right-triangle-shaped coulter blade fins (2) attached perpendicularly directly to both sides of the coulter blade. Though a coulter blade fin in the shape of a right triangle works best with the wavy coulter blade, coulter blade fins in other shapes, such as different triangular shapes, rectangles, and more could be used as well. Though doing so would be less effective, it is possible to have the coulter blade fins attached only to one side of the coulter blade.

In the preferred embodiment, as shown in FIG. 1, the coulter blade fins are at a ninety-degree angle to the center and edge of the coulter blade, but the coulter blade fins could tilt forward or backward as desired provided they remain perpendicular to the coulter blade surface.

In the preferred embodiment, the coulter blade fins are one-quarter inch thick. Other thicknesses may be used to better suit the user's needs. The thickness of the coulter blade fins is independent of the thickness of the coulter blade.

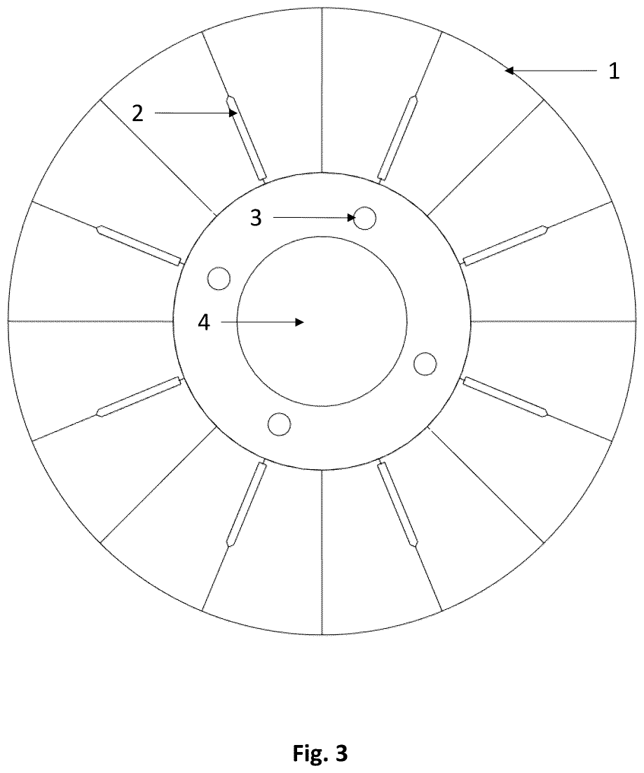

In this preferred embodiment, there are eight coulter blade fins spaced evenly around the side of the coulter blade, as depicted in FIG. 3. The number of coulter blade fins attached to the coulter blade, and their spacing, will vary based on the needs of the user, which will depend on the type of crop being harvested, the type of harvester being used, and the tillage results the user wishes to have.

The coulter blade has a large blade assembly hole (4) in its center to accommodate the assembly attachment that attaches the coulter blade to a tillage arm, and around that blade assembly hole, at least four blade bolt holes (3) to allow the coulter blade to be attached to the assembly attachment.

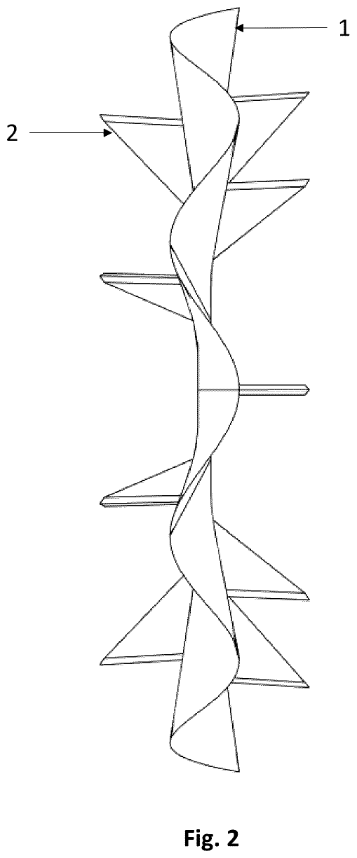

As in FIG. 2, the length the coulter blade fins extend out from the coulter blade is at least several inches, such that the width of the coulter blade plus coulter blade fins is sufficient to extend the footprint of coverage of a crop row by the coulter blade beyond the regular width of the crop row, so the crop residue will be pulverized properly into the soil even if the coulter blade isn't lined up perfectly with the crop row, yet without being long enough to collide with such coulter blade fins on adjacent coulter blades attached to the same harvester header or other harvester headers. The appropriate length the coulter blade fins extend out from the coulter blade depends on the size of the coulter blade, the distance between the coulter blades, and the width of the crop rows.

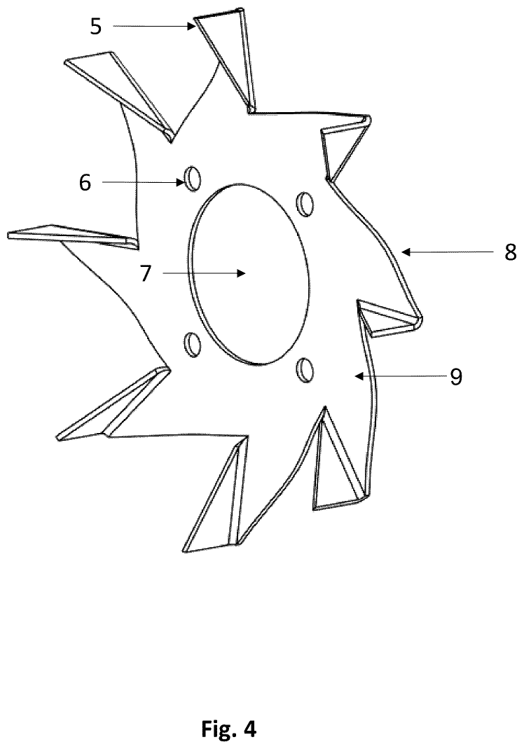

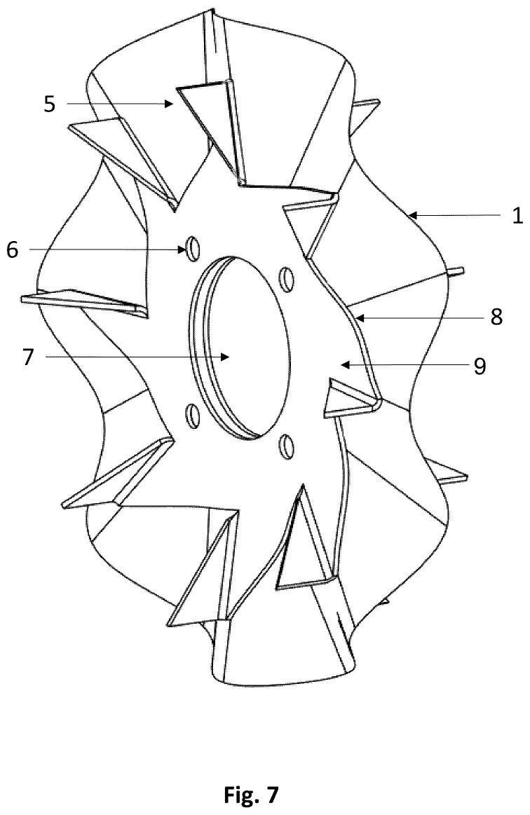

A second embodiment of the present invention, depicted by itself in FIG. 4, and shown fitted to a coulter blade in FIG. 7, is a fin attachment (8) of diameter slightly smaller than that of the coulter blade it is used with. The fin attachment has a disc-shaped fin attachment base (9) that is wavy to match the wave pattern of a wavy coulter blade so the fin attachment may fit snugly against a wavy coulter blade as shown in FIG. 7. Though it would be less effective, if the coulter blade is a flat blade rather than a wavy blade, then the fin attachment base would be flat as well to fit snugly against the coulter blade. Whatever the shape of the coulter blade, the fin attachment base is shaped to fit flush against the coulter blade.

The fin attachment base has a fin attachment assembly hole (7) in its center to accommodate the assembly attachment that attaches the coulter blade to a tillage arm. Around that fin attachment assembly hole are at least four fin attachment bolt holes (6) to allow the fin attachment to be attached flush to the coulter blade with bolts. Ideally, a fin attachment is attached to both sides of the coulter blade to provide the maximum footprint of coverage, as depicted in FIG. 7. Though doing so would be less effective, it is possible to attach a fin attachment to only one side of the coulter blade.

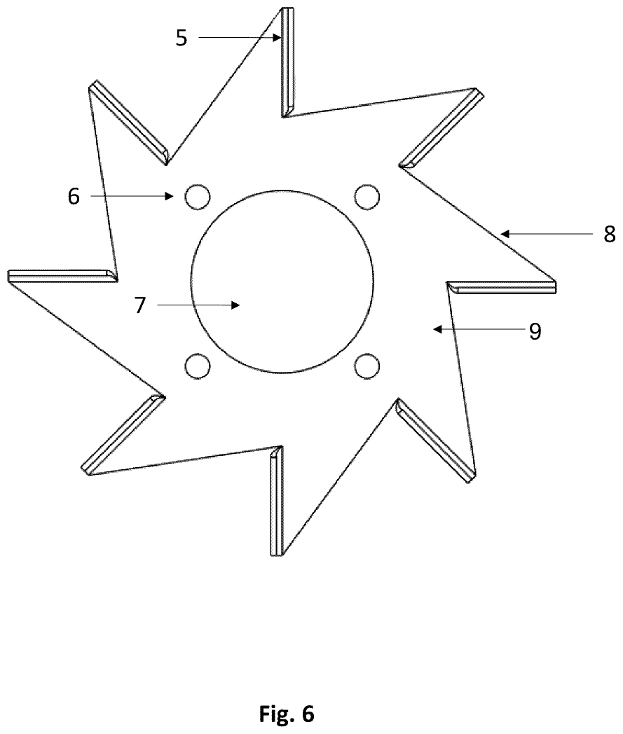

Bending up perpendicularly from the fin attachment base, just past the area occupied by the fin attachment bolt holes and extending to the edge of the fin attachment, are a series of right-triangle-shaped fin attachment fins (2), having their right angle at the outer edge of the fin attachment and their acute angles toward the center of the fin attachment base and pointing away from the fin attachment base and the plane of the coulter blade as shown in FIG. 4. As FIG. 4 shows, the fin attachment fins are triangular shapes that appear peeled back from the fin attachment base, leaving a cutout shape of the triangle that has been peeled back. FIG. 6 shows the triangular cutout shapes left by the fin attachment fins being bent back perpendicular from the fin attachment base as described. Though a fin in the shape of a right triangle works best with the wavy coulter blade, fins in other shapes, such as different triangular shapes, rectangles, and more could be used as well.

In this second embodiment, the fin attachment fins are bent back from the fin attachment base, the fins and fin attachment base being all one piece. It is also possible that the fin attachment fins may be separate pieces attached to the fin attachment base, in which case no corresponding cutouts of the fin attachment fins in the fin attachment base would exist.

In FIG. 6, the fin attachment fins are at a ninety-degree angle to the center of the fin attachment base, but the fin attachment fins could tilt forward or backward so they are angled at more than or less than ninety degrees to the center of the fin attachment base as desired, provided the fin attachment fins remain perpendicular to the fin attachment base.

In the second embodiment, the fin attachment fins are one-quarter inch thick. Other thicknesses may be used to better suit the user's needs. The thickness of the fin attachment fins is independent of the thickness of the coulter blade.

In the second embodiment, there are eight fin attachment fins spaced evenly and radially around the fin attachment base, as depicted in FIG. 6. The number of fin attachment fins, and their spacing, will vary based on the needs of the user, which will depend on the type of crop being harvested, the type of harvester being used, and the tillage results the user wishes to have.

As depicted in FIG. 7, the length the fin attachment fins extend out from the fin attachment base, which is flush with the coulter blade, is at least several inches, such that the width of the coulter blade plus a fin attachment, on one or both sides of the coulter blade, is sufficient to extend the footprint of coverage by the coulter blade and attached fin attachments beyond the regular width of the crop row so the crop residue will be pulverized properly into the soil even if the coulter blade isn't lined up perfectly with the crop row, yet without being long enough to collide with fin attachments on adjacent coulter blades attached to the same harvester header or other harvester headers. The appropriate length the fin attachment fins extend out from the fin attachment base depends on the size of the coulter blade, the distance between the coulter blades, and the width of the crop rows.

The invention claimed is:

1. A coulter blade with a series of coulter blade fins attached directly and perpendicularly to the surface of said coulter blade and arranged radially around the center of said coulter blade, said coulter blade fins being of a length extending out from said coulter blade that widens the footprint of row coverage of said coulter blade.

2. A fin attachment for a coulter blade comprising:
a. A disc-shaped fin attachment base for attaching flush to a side of said coulter blade;
b. A fin attachment assembly hole in the center of said fin attachment base to accommodate an assembly attaching said coulter blade to a tillage assembly;
c. At least four fin attachment bolt holes around said fin attachment assembly hole for attaching said fin attachment to said coulter blade with bolts; and
d. Extending from the outer edge of said fin attachment base to the area of the fin attachment base just before said fin attachment bolt holes, a series of fin attachment fins arranged radially around the center of said fin attachment base and perpendicular to said fin attachment base, said fin attachment fins being of a length extending out from said fin attachment base that when said fin attachment base is attached to said coulter blade the footprint of row coverage of said coulter blade is widened.

3. A system for expanding coverage area for a coulter blade such that a row crop may be knocked over, sliced, and pulverized into the soil after harvesting even if alignment of a crop row with said coulter blade is not perfect, the system comprising a series of coulter blade fins attached directly and perpendicularly to said coulter blade, radially around the center of said coulter blade, said coulter blade fins being of a size that widens the footprint of the area of row crop residue that can be knocked over, sliced, and pulverized by said coulter blade while said coulter blade embeds some of said residue into the soil.

4. A system for expanding coverage area for a coulter blade such that a row crop may be knocked over, sliced, and pulverized into the soil after harvesting even if alignment of a crop row with said coulter blade is not perfect, the system comprising: a coulter blade; a fin attachment comprising a disc-shaped fin attachment base attached flush to said coulter blade, and a series of fin attachment fins perpendicular to said fin attachment base and said coulter blade, arranged radially around the center of said fin attachment base, said fin attachment fins being of a length extending out from said fin attachment base such that when said fin attachment base is attached to said coulter blade the footprint of the area of row crop residue to be knocked over, sliced, and pulverized by said coulter blade while said coulter blade embeds some of said residue into the soil is widened.
